(19) United States
(12) Patent Application Publication
(10) Pub. No.: US 2026/0023752 A1
(43) Pub. Date: Jan. 22, 2026

(54) MONITORING ONLINE ACTIVITY FOR REAL-TIME RANKING OF CONTENT

(71) Applicant: Kunato Inc., New York, NY (US)

(72) Inventors: Illan Poreh, New York, NY (US); Assaf Zeevi, New York, NY (US); Madhusudhanan Krishnamoorthy, Bangalore (IN); Chaikesh Chouragade, Bangalore (IN)

(21) Appl. No.: 19/339,491

(22) Filed: Sep. 25, 2025

Related U.S. Application Data
(62) Division of application No. 18/607,601, filed on Mar. 18, 2024.
(60) Provisional application No. 63/454,106, filed on Mar. 23, 2023.

(51) Int. Cl. G06F 16/2457; G06F 16/28

(52) U.S. Cl. CPC G06F 16/24578; G06F 16/285

(57) ABSTRACT

According to an embodiment of the present invention, a content item containing content is received. A value for the content item is determined based on values of one or more content items associated with the content item. Online activity related to the content item is monitored, and the value for the content item is updated in real-time based on the user activity. The value for the content item is displayed as the value changes in real-time. Embodiments of the present invention may include one or more methods, computer program products, and systems for monitoring user activity and updating a value for a content item in real-time. Embodiments of the present invention may further include identifying value curves of a one or more plurality of content items associated with the new content item, and combining the identified value curves to produce a value curve for the new content item.

### CROSS-REFERENCE TO RELATED APPLICATIONS

This application is a divisional application of U.S. patent application Ser. No. 18/607,601, filed Mar. 18, 2024; which claims priority to U.S. Provisional Patent Application Ser. No. 63/454,106, entitled “MONITORING ONLINE ACTIVITY FOR REAL-TIME RANKING OF CONTENT” and filed Mar. 23, 2023, the disclosures of which are incorporated herein by reference in their entireties.

### TECHNICAL FIELD

Present invention embodiments relate to content distribution and search systems, and more specifically, to monitoring online activity and adjusting content ranking in real-time using machine learning.

### BACKGROUND

A wide variety of content is accessible via the Internet. The content includes, for example, news articles, blogs, tweets, images, chats, and the like. The content is provided by online publishers, such as, magazines, newspapers, periodicals, databases, and other information services. Conventional search engines typically analyze characteristics of potential search results without actually evaluating content in order to provide and arrange relevant search results. For example, these search engines may count the number of links for a website, a number of clicks or accesses for the website, and the characteristics/popularity of other websites linked to the website. This may lead to popular results of lower quality content being discovered and prioritized over results with higher quality content. The prioritization may be the same even though the quality of the website may change. In addition, these search engines may require substantial time to crawl the Internet, or have long time intervals between crawling, so that the prioritization may become outdated and not reflect current demand for content.

### SUMMARY

According to one embodiment of the present invention, a content item containing content is received. A value for the content item is determined based on values of one or more content items associated with the content item content comparisons as well as by looking at the intrinsic features on multiple aspect of content called content genome. Online activity related to the content item is monitored, and the value for the content item is updated in real-time based on the user activity. The value for the content item is displayed as the value changes in real-time. Embodiments of the present invention may include one or more methods, computer program products, and systems for monitoring user activity and updating a value for a content item in real-time in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3A is a block diagram of the content module of FIG. 1 according to an embodiment of the present invention.

FIG. 3B is a block diagram of the content genome according to an embodiment of the present invention.

FIG. 4 is procedural flowchart illustrating a manner of determining a value for content items in real-time based on online activity according to an embodiment of the present invention.

FIG. 5A is a procedural flowchart illustrating a manner of updating value curves of content items according to an embodiment of the present invention.

FIG. 5B is a procedural flowchart illustrating an example implementation of the invention using data from a crawler and generating content genome and value curves.

FIG. 5C is a procedural flowchart illustrating feedback loops from the users integrated into the system to retrain the machine learning model.

FIG. 5D is a procedural flowchart illustrating dynamically changing weight values based on a surge.

FIG. 6A is an illustration of generating a value curve for a new content item based on value curves of associated content items according to an embodiment of the present invention.

FIG. 6B is an illustration of updating the value curve for the new content item of FIG. 6A according to an embodiment of the present invention.

FIG. 7A is a schematic illustration of an example graphical user interface providing content items and associated values updated in real-time according to an embodiment of the present invention.

FIG. 7B is a schematic illustration of the example graphical user interface of FIG. 7A providing historical information for a content item according to an embodiment of the present invention.

FIG. 7C is a schematic illustration of the example graphical user interface of FIG. 7A providing historical information for different historical period for a content item according to an embodiment of the present invention.

### DETAILED DESCRIPTION OF EXAMPLE EMBODIMENTS

Present invention embodiments analyze content items as well as network operations (or accesses) for the content items in order to discover, prioritize, and arrange content items for results. A content item may be any type of digital or electronic item or object (e.g., document, web page, file, data object, etc.) containing any type, or a combination of any types, of data (e.g., text, multimedia, video, audio, image, streaming data, etc.). For example, a content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc. A content item may be associated with an indicator or link enabling access to the content item. As content items and access for the content items change, a value or ranking for the content items similarly changes. The value or ranking of the content items is determined in real-time so that the values are dynamically updated in real-time while the content items or results are presented to users (e.g., similar to a continuously updated and changing stock ticker, etc.).

Incorporating real-time updates into the system is crucial as it considers not only online user activity but also information propagation and price updates to similar content items. This is particularly significant in scenarios where real-time online activity data may not be readily accessible. By leveraging information propagation and price updates, the system ensures a comprehensive understanding of market dynamics and content interactions. This approach enables the system to dynamically adjust pricing strategies in response to evolving trends and demand shifts, ensuring timely and effective decision-making. By integrating both online activity data and external updates, the system can maintain responsiveness and accuracy in pricing, thereby enhancing its effectiveness in meeting user needs and maximizing revenue opportunities.

An embodiment of the present invention is designed to be equitable and transparent for users creating content items and users obtaining content items. The present invention embodiment uses machine learning models and natural language processing (NLP) techniques to analyze content items and user behavior in order to determine values for the content items.

For example, when a content creator uploads a new content item, a present invention embodiment performs an initial value prediction based on historical data and various factors, such as popularity of a brand, audience demographics, and previous transaction data for similar content items. The present invention embodiment uses real-time user behavior, based on different markets and needs, to adjust the value of the new content item as greater interaction with the new content item occurs.

In some cases, value of a content item may change rapidly due to demand or changes in the audience. For example, a content item that is important for a few users may have a very high value for the first 1-2 minutes, and then decrease significantly to adjust to a wider spectrum of users. A present invention embodiment considers these different scenarios, and adjusts the value accordingly to ensure that the value remains equitable and transparent for users creating content items and users obtaining content items.

A present invention embodiment is equitable since value is based on actual data, rather than arbitrary value decisions. The present invention embodiment considers a wide range of factors, both historical and real-time, to accurately predict demand for content items and optimize a value in an equitable and transparent manner for each different audience. This helps to ensure that users creating content items and users obtaining content items are provided with an equitable transaction for content items.

In addition, a present invention embodiment is advantageous since the value is mutually beneficial to users creating content items and users obtaining content items. Content creators may offer their content items at values that accurately reflect the content items, without having to guess or undersell, while users may obtain the content item, they want at a value that is competitive and reflects the real-time demand. This means that users creating content items and users obtaining content items are provided with an equitable transaction and are able to participate in a dynamic online marketplace that is transparent and efficient.

When the value of a content item is low enough, users have the option to obtain the content item with an advertisement, such as a pre-roll video or a coupon. This allows users to access the content item they want, even if they cannot afford the full value, while also providing content creators with an additional stream of revenue through advertising. Overall, this feature creates a more inclusive and accessible online marketplace for users creating content items and users obtaining content items.

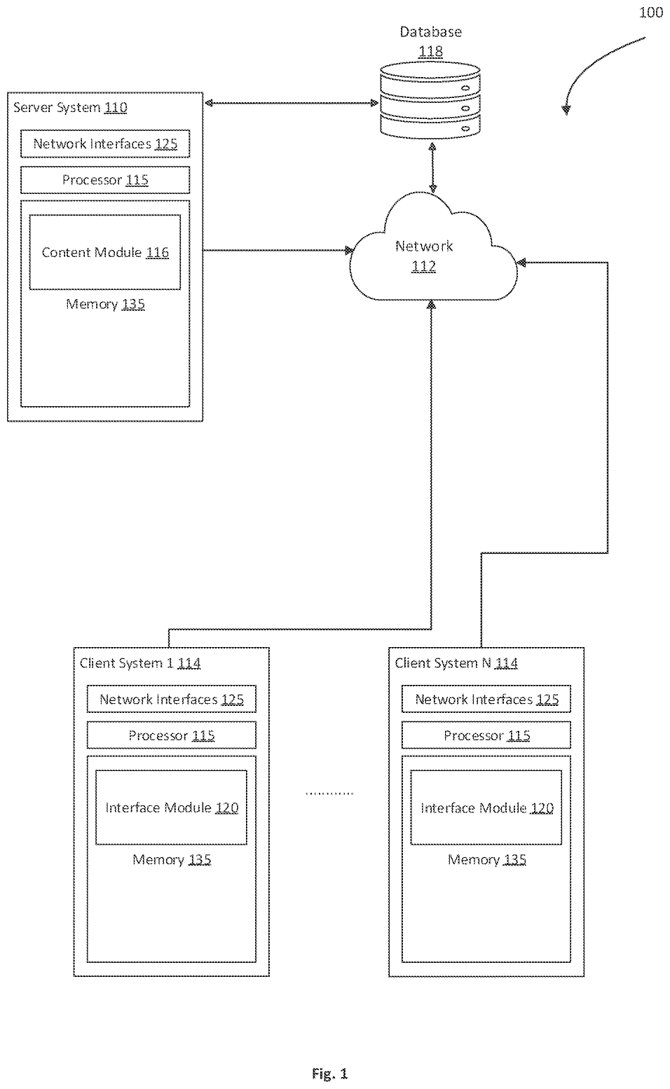

An example environment for use with present invention embodiments is illustrated in FIG. 1. Specifically, an environment 100 includes one or more server systems 110, and one or more client or end-user systems 114. Server systems 110 and client systems 114 may be remote from each other and communicate over a network 112. The network may be implemented by any number of any suitable communications media (e.g., wide area network (WAN), local area network (LAN), Internet, Intranet, etc.). Alternatively, server systems 110 and client systems 114 may be local to each other, and communicate via any appropriate local communication medium (e.g., local area network (LAN), hardwire, wireless link, Intranet, etc.).

Client systems 114 enable users to interact with server systems 110 to provide (or upload) and/or obtain content items. A content item may be any type of digital or electronic item or object (e.g., document, web page, file, data object, etc.) containing any type, or a combination of any types, of data (e.g., text, multimedia, video, audio, image, streaming data, etc.). The server systems include a content module 116 to manage content items as described below. Content module 116 enables users to upload content items, and facilitates searching and transactions for users to identify and obtain desired content items. The content module determines values for content items in real-time based on monitoring online user activity with respect to the content items. The values may be updated on a user display in real-time as user activity with respect to the content items changes (e.g., similar to a continuously updated and changing stock ticker, etc.).

A database system 118 may store various information for the analysis (e.g., activity measurements, value curves, content items, values, etc.). The database system may be implemented by any conventional or other database or storage unit, may be local to or remote from server systems 110 and client systems 114, and may communicate via any appropriate communication medium (e.g., local area network (LAN), wide area network (WAN), Internet, hardwire, wireless link, Intranet, etc.).

The client systems may include an interface or browser module 120 that presents a graphical user (e.g., GUI, etc.) or other interface (e.g., command line prompts, menu screens, etc.). The graphical user interface solicits information from users pertaining to providing and/or obtaining content items, and may provide results of content searches with continuously updated values.

Server systems 110 and client systems 114 may be implemented by any conventional or other computer systems preferably equipped with a display or monitor, a base, optional input devices (e.g., a keyboard, mouse or other input device), and any commercially available and custom software (e.g., server/communications software, content module 116, interface/browser module 120, etc.). The base includes at least one hardware processor 115 (e.g., microprocessor, controller, central processing unit (CPU), etc.), one or more memories 135, and/or internal or external network interfaces or communications devices 125 (e.g., modem, network cards, etc.)).

Various modules of present invention embodiments (e.g., content module 116, interface module 120, etc.) may include one or more modules or units to perform the various functions of present invention embodiments described below. The various modules (e.g., content module 116, interface module 120, etc.) may be implemented by any combination of any quantity of software and/or hardware modules or units, and may reside within memory 135 of the server and/or client systems for execution by processor 115.

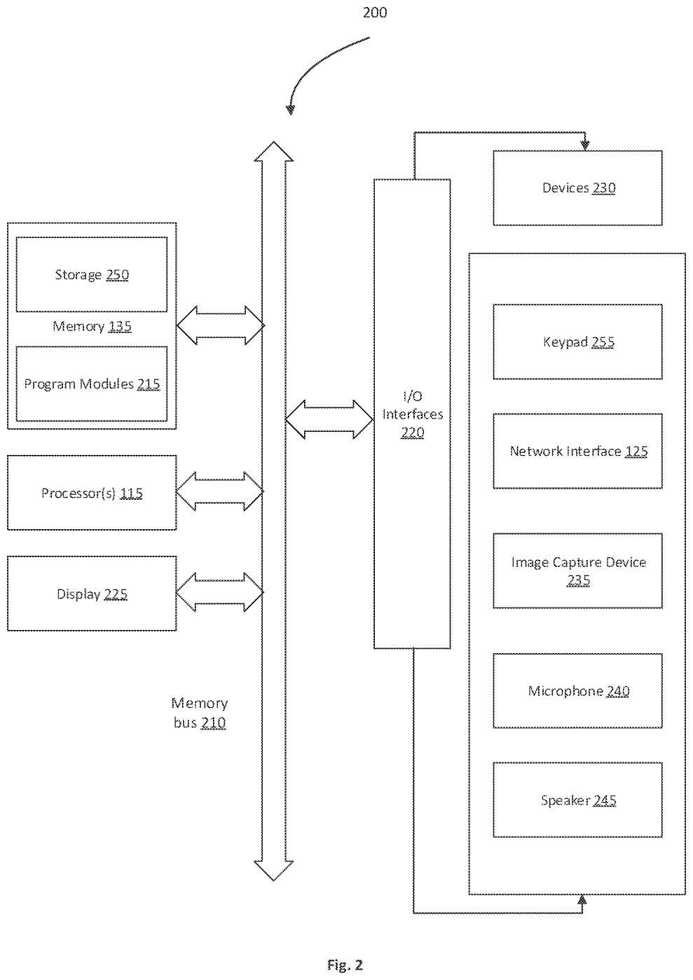

An example of a computing device 200 of environment 100 (e.g., implementing server system 110 and/or client system 114) is illustrated in FIG. 2. The example computing device may perform the functions described herein. Computing device 200 may be implemented by any personal or other type of computer or processing system (e.g., desktop, laptop, hand-held device, tablet, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to content module 116, interface module 120, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, etc.), at least one device that enables a user to interact with computing device 200, and/or any device (e.g., network card, modem, etc.) that enables computing device 200 to communicate with one or more other computing devices. Computing device 200 may communicate with one or more networks (e.g. a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

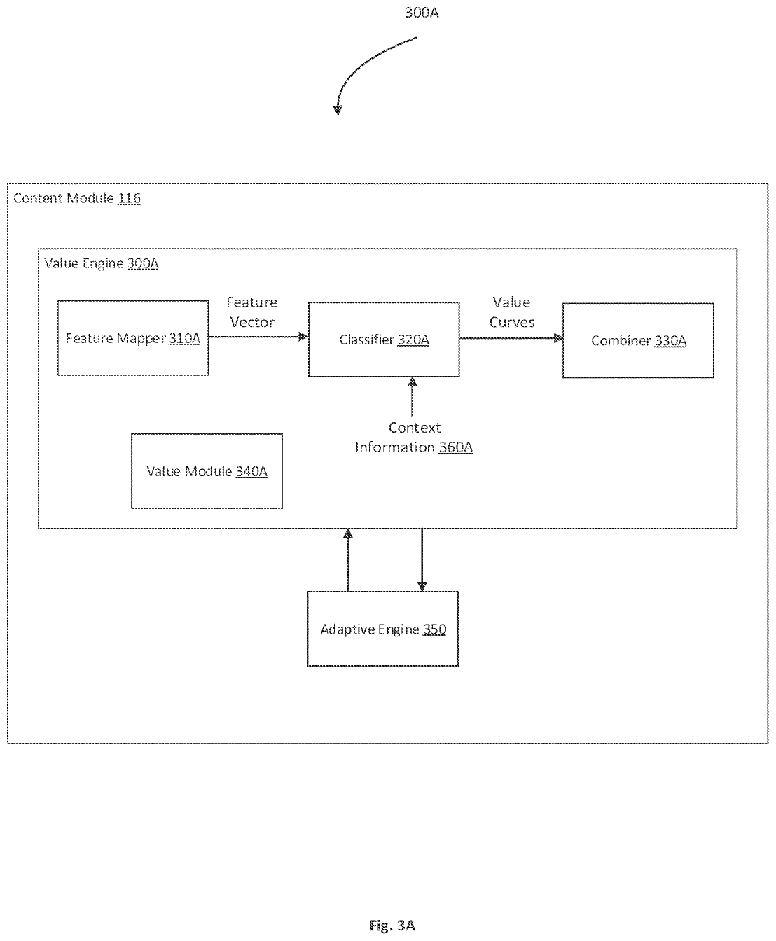

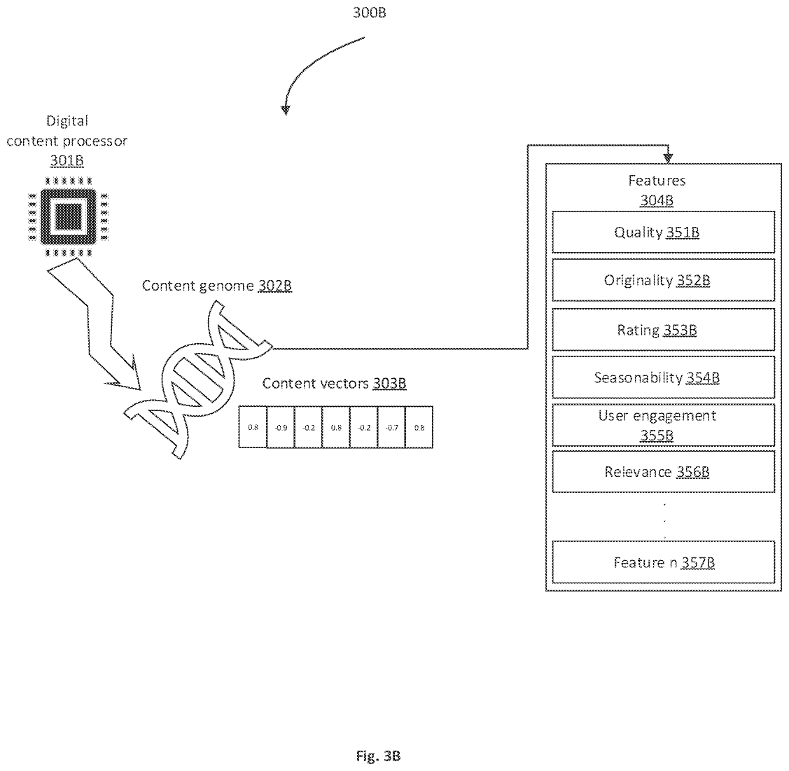

A block diagram of content module 116 is illustrated in FIG. 3A. Specifically, content module 116 includes a value engine 300A and an adaptive engine 350A. The value engine determines a value for content items based on value curves for the content items, while the adaptive engine continuously updates value curves for content items in real-time (or near real-time) based on online user activity with respect to the content items.

Value engine 300A includes a feature mapper 310A, a classifier 320A, a combiner 330A, and a value module 340A. Feature mapper 310A analyzes a content item (e.g., uploaded by a user via a client system 114) to extract features therefrom and produce a feature vector. The feature vector includes a plurality of dimensions or elements each indicating a feature of the content item. The features may be extracted using any conventional or other natural language processing (NLP) techniques (e.g., entity extraction, relationship extraction, sentiment/emotion analysis, keyword extraction, part-of-speech (POS) tagger, etc.). In the case of the content item including audio, the feature mapper may transcribe the audio to text to extract the features and produce a feature vector via any conventional or other natural language processing (NLP) and/or automatic speech recognition (ASR) techniques. The features may include any quantity of any types of features (e.g., keywords, topics, events, word count, word frequency, word embeddings, term frequency-inverse document frequency (tf-idf), etc.).

Classifier 320A analyzes the feature vector for the content item from feature mapper 310A and contextual information for the content item, and identifies one or more value curves of other content items associated with the content item (e.g., stored in database system 118). The classifier may employ any conventional or other nearest neighbor technique (e.g., K-nearest neighbor, etc.) to identify nearest value curves (or content items). In this case, feature mapper 310A may weight features in the feature vector to enable the classifier to identify value curves of content items based on the features with greater weights (e.g., value curves may be identified based on similarity of content item features with greater weight, etc.). The identified value curves indicate values for the associated content items over time, and are combined to produce a value curve for the content item as described below. The contextual information may include any attributes providing a context for the content item (e.g., location, popularity of a brand, audience demographics, buying power, brand, event described, type of content, etc.). A portion of the context information may be extracted by feature mapper 310A using natural language processing (NLP).

Classifier 320A may employ one or more machine learning models to identify the one or more value curves for the content item. The machine learning models may be implemented by any conventional or other machine learning models (e.g., mathematical/statistical; classifiers; feed-forward, deep learning, recurrent, large language model (LLM), convolutional or other neural networks; etc.). By way of example, classifier 320A may include a neural network.

For example, a neural network may include an input layer, one or more intermediate layers (e.g., including any hidden layers), and an output layer. Each layer includes one or more neurons, where the input layer neurons receive input (e.g., feature vectors of content items, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of feature vectors of content items as input and corresponding classifications (e.g., value curves of associated content items, etc.) as known outputs, where the neural network attempts to produce the known output (or classification) and uses an error from the output (e.g., difference between produced and known outputs) to adjust weight (and bias) values (e.g., via backpropagation or other training techniques).

In an embodiment, the machine learning may be performed using a training set of feature vectors of content items and context information as input and known value curves of associated content items as outputs, where the neural network attempts to produce the provided output (or value curves of associated content items).

The dynamic pricing system integrates a diverse set of machine learning models tailored to specific functionalities. These models include sentiment analysis models, such as neural networks, or recurrent neural networks (RNNs), which are employed to analyze user sentiments regarding content. They are trained on labeled datasets for sentiment classification. Additionally, clustering algorithms like K-means, hierarchical clustering, or DBSCAN are utilized to group similar articles based on content attributes. These algorithms extract features and apply clustering techniques for content categorization. Furthermore, reinforcement learning algorithms form part of the system's dynamic pricing models. These models optimize pricing strategies by leveraging user interactions and market dynamics, with continuous learning mechanisms in place to maximize revenue.

The output layer of the neural network indicates a classification (e.g., value curve, etc.) for input data. By way of example, the classes used for the classification may include a class associated with each value curve of content items. The output layer neurons may provide classifications (or specify particular classes) that indicate corresponding value curves of associated content items. For example, the output layer neurons may be associated with the different classes, and indicate a probability for the input data being within a corresponding class (e.g., a probability of the input data being in a class associated with a corresponding value curve of an associated content item, etc.). The classes associated with the highest probabilities are preferably selected as the classes (or value curves of associated content items) for the input data. Classifier 320A may identify any quantity of value curves of content items associated with the content item to produce the value curve for the content item. In addition, the classifier may be trained on the content of a content item (or a combination of the content and the feature vectors) to produce the value curves.

Combiner 330A processes the value curves from classifier 320A to produce a value curve for the content item. The combiner may select the identified value curves or any portion of the identified value curves to use for producing the value curve for the new content item. By way of example, the combiner may filter the identified value curves based on various criteria (e.g., use a predetermined number of the identified value curves (e.g., with the highest probabilities, etc.), similarity metrics between the content item and content items associated with the identified value curves, most recent value curves, etc.). The selected value curves are combined by weighting the values of each selected value curve to produce the value curve for the content item. The value curve indicates values for the content item over time, and content module 116 assigns a value to the content item based on the value curve. Thus, the value of the content item changes over time according to the value curve. The weight values for combining the selected value curves may be determined based on any desired criteria (e.g., probabilities for the selected value curves, similarity metrics between feature vectors of the content item and associated content items (e.g., Euclidean or other distance, cosine similarity, etc.), etc.).

Value module 340A accesses corresponding value curves for content items to extract or determine values for the content items over time (e.g., retrieve a value from a value curve corresponding to a current time, etc.). The value module may update values for content items at certain time intervals (e.g., seconds, minutes, etc.), and/or in response to any updates to a value curve.

Adaptive engine 350A monitors activity with respect to each content item. The adaptive engine receives value curves for content items, and updates the value curves for content items at predetermined time intervals (e.g., seconds, minutes, etc.) based on the monitored activity. The activity may include any online or other activities with respect to content items (e.g., clicks to access/initiate a transaction, cursor hover time, selection of content items, views of advertisements, etc.). The updated curves and any additional context information from activity monitoring are provided to value engine 300A. Value module 340A provides updated values for content items based on the updated value curves. In addition, the updated value curves may be used as new curve instances for training classifier 320A to enable the updated curves to be selected and used for determining a value curve for subsequent content items. The updated curves may be associated with additional context information 360A from monitoring activity corresponding to the content items (e.g., new location, audience, buying power, etc.).

Natural Language Processing (NLP) techniques play a vital role in extracting meaningful insights from textual content within the dynamic pricing system. These techniques encompass various tasks and algorithms aimed at enhancing the system's understanding and analysis of textual data. Firstly, text preprocessing tasks such as tokenization, stemming, and removal of stop words are performed to clean and prepare textual data for further analysis. Secondly, Named Entity Recognition (NER) tasks are employed to identify entities such as people and locations within the text, thereby enhancing the understanding of the content context. Lastly, the system utilizes topic modeling algorithms such as Latent Dirichlet Allocation (LDA) and Non-Negative Matrix Factorization (NMF) to identify prevalent topics in articles, facilitating more nuanced analysis and decision-making processes.

FIG. 3B is a block diagram that illustrates an architecture on how the content vectors are generated using the content genome. In an embodiment of the invention 300B, a digital content processor 301B is configured to generate content vectors 303B dynamically based on content genome 302B. The content genome 302B comprises multiple features 304B such as quality 351B, originality 352B, rating 353B, seasonability 354B, user engagement 355B, relevance 356B, etc. The system employs a sophisticated algorithm that analyzes content genome 302B inherent to the content. Leveraging advanced machine learning techniques, the digital content processor 301B autonomously identifies key patterns and relationships within the content, enabling the creation of content vectors 303B that encapsulate the nuanced information present. The dynamic vector generation process adapts to the evolving nature of the content, ensuring an adaptive and responsive representation.

Table 1 illustrates the attribute vector inputs content genome database or from the analytics. TABLE 1:

| No. | Analytics | Database | Analytics Insights |
|---|---|---|---|
| 1 | Content Quality | Content Genome | Track distribution of content |
| | Analysis | Database | quality scores over time in |
| | | | comparison to market trends |
| 2 | Topic Engagement | Content Genome | Analyze popularity of different |
| | | Database | content topics |
| 3 | Rating Trends | Content Genome | Monitor distribution of user |
| | | Database | ratings for content in comparison |
| | | | to market trends |
| 4 | Language Preferences | Content Genome | Understand language distribution |
| | | Database | of content |
| 5 | Seasonality Impact | Analytics | Explore content engagement |
| | | | variations with seasons |
| 6 | Average QMV Analysis | Content Genome | Track average Quality against |
| | | Database | Average Market value across |
| | | | contents per domain of content |
| 7 | User Engagement | Analytics | Track user engagement metrics |
| | Analysis | | (session duration, interaction |
| | | | frequency) |
| 8 | Content Domain | Analytics | Analyze user interactions based |
| | Performance | | on the domain of content |
| 9 | User Journey Analysis | Analytics | Create user journey visualizations |
| | | | to understand how users navigate |
| | | | through the contents |
| 10 | Time Spent on Content | Analytics | Analyze average time users spend |
| | | | on different types of contents |
| 11 | Valuation Trends | Valuation | Track changes in content |
| | | | valuation over time |
| 12 | Comparison with | Valuation | Compare initial content price |
| | Initial Price | | with its valuation |
| 13 | Valuation Forecast | Valuation | Utilize historical data to forecast |
| | | | valuation for the next 72 hours |
| 14 | Correlation with | Valuation | Explore correlation between content |
| | User Engagement | | valuation and user engagement metrics |
| 15 | Content ROI Analysis | Cross-Database | Combine data from Content |
| | | Insights | Genome and Valuation databases |
| 16 | Content Performance by | Cross-Database | Analyze user interactions based |
| | language and domain | Insights | on both language and |
| 17 | User Engagement and | Cross-Database | Explore future valuation based |
| | Valuation forecast | Insights | on user engagement |

In an embodiment of the invention, a value for the content item is determined based on values of one or more content items associated with the content item content comparisons as well as by looking at the intrinsic features on multiple aspect of user called user genome and by looking at the intrinsic features on multiple aspect of publisher called publisher genome.

In another embodiment of the invention, the publisher genome encompasses a multifaceted profile capturing the identity, behavior, and historical performance metrics of content publishers within the dynamic pricing framework. This comprehensive profile facilitates the segmentation of publishers for tailored pricing strategies, incorporating elements such as identity and reputation, content portfolio, engagement metrics, monetization history, user demographics, and compliance and ethics standards. By leveraging the Publisher Genome, the pricing system ensures publishers are aligned with optimal pricing structures, enhancing transparency and efficiency in content valuation and distribution.

In another embodiment of the invention, the user genome serves as a dynamic profile that encapsulates user preferences, behaviors, and interactions to drive personalized and responsive content pricing. This evolving profile incorporates user preferences, interaction history, engagement metrics, dynamic pricing response, content attributes, trends and seasonality, and competitive content consumption patterns. By integrating the User Genome with the Publisher Genome, the pricing system achieves a symbiotic relationship that enables dynamic pricing adjustments based on both content value and user preferences, thereby enhancing user satisfaction and optimizing revenue generation for publishers.

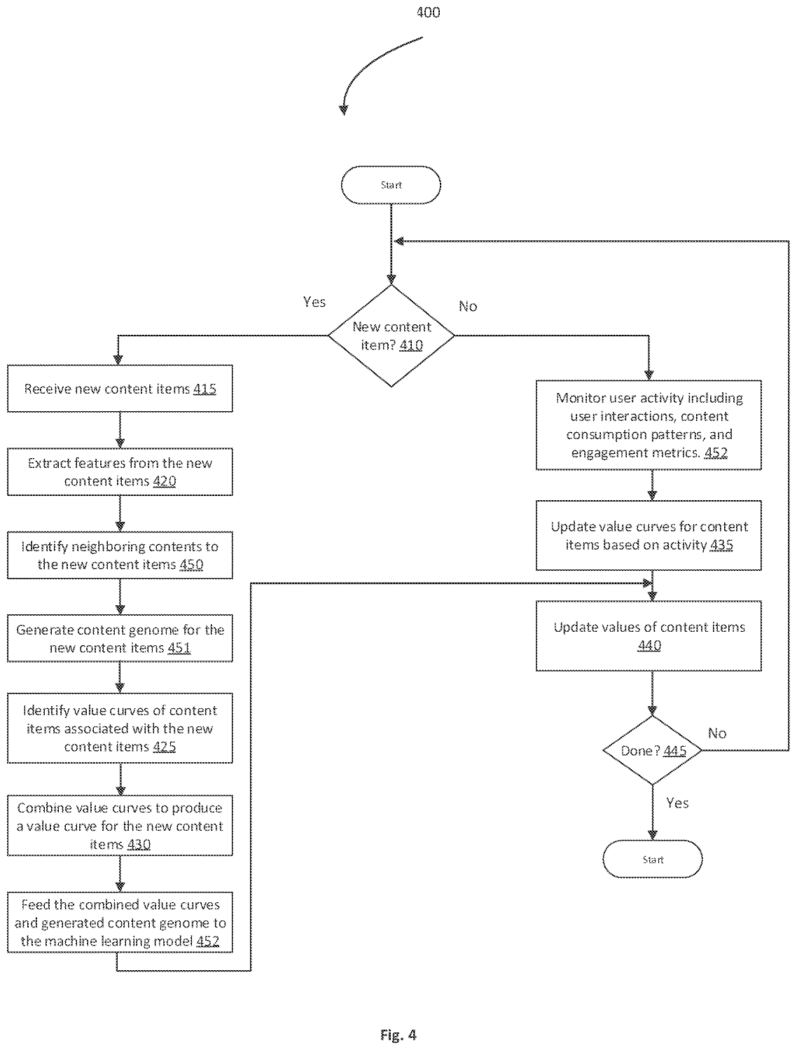

A method 400 of determining values for content items in real-time (e.g., via content module 116, interface module 120, server system 110 and/or client system 114) according to an embodiment of the present invention is illustrated in FIG. 4. Initially, reference value curves are generated for an initial set of content items at operation. The reference value curves may be generated based on experimental data (e.g., a randomized control trial (RCT) of user activity with respect to the initial set of content items, etc.). The reference value curves indicate predictions for values of the initial set of content items over time. The initial set of content items and corresponding value curves are used to produce value curves for subsequent content items as described below.

Value curves and values for content items are continuously being updated, while new content items are processed. The updates to the value curves basically correct the value predictions based on user activity. In particular, when a user provides (e.g., uploads or registers) a new content item (e.g., via a client system 114) as determined at operation 410, the new content item is received by value engine 300A for processing at operation 415. The new content item may be any type of digital or electronic item or object (e.g., document, web page, file, data object, etc.) containing any type, or a combination of any types, of data (e.g., text, multimedia, video, audio, image, streaming data, etc.). For example, the new content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc. Value module 340A may generate a new content ledger or other data structure to record future transactions or other activities involving the new content item. The ledger may be stored in database system 118.

An initial value curve for the new content item is determined based on value curves of previous content items. Weight values are used to determine a relative importance for (or contribution from) a value curve of each previous content item in generating the value curve for the new content item. The value curve for the new content item is determined by a weighted sum of the values from the value curves of the previous content items as described below.

The value curves of content items indicate values for the content items over time, and may be expressed as a polynomial function (e.g., regression polynomial, etc.) of degree n. The degree of the polynomial may be of any value, but is preferably greater than or equal to two. The polynomial function for a value curve may be expressed as:

$$V ( X ) = {C}_{0} + {C}_{1} X + {C}_{2} {X}^{2} … {C}_{n} {X}^{n} ,$$

where V(X) is the value function or curve with respect to variable X (e.g., time), and C₀ to Cₙ are coefficients with C₀ representing a Y-intercept.

The characteristics or properties of the polynomial function may be stored (e.g., coefficients, degree, etc.), and subsequently retrieved and applied according to the expression to produce data points along the value curve (e.g., a value for a content item at a point in time, etc.). This avoids storage and calculation of all of the data points for a value curve, thereby increasing processing speed and conserving memory. A value curve for a content item may be any function, plot, graph element, or other object (e.g., table, list, etc.) conveying values for the content item over time (e.g., a flat curve or line, any curve, any combination of curved and/or linear portions, step-wise function or graph, etc.).

In order to identify value curves of previous content items, feature mapper 310A analyzes the new content item and extracts features from the new content item at operation 420 to produce a feature vector. The feature vector includes a plurality of dimensions or elements each indicating a corresponding feature of the new content item. The features may include any quantity of any types of features (e.g., keywords, topics, events, word count, word frequency, word embeddings, term frequency-inverse document frequency (tf-idf), etc.). Further, the feature mapper may extract context information from the new content item. The context information may include any attributes providing a context for the new content item (e.g., location, brand, event described, type of content, etc.). The feature mapper may employ any conventional or other natural language processing (NLP) techniques (e.g., entity extraction, relationship extraction, sentiment/emotion analysis, keyword extraction, part-of-speech (POS) tagger, etc.) to identify and/or extract the features and/or context information. In the case of the new content item including audio, the feature mapper may transcribe the audio to text to extract the features and produce a feature vector via any conventional or other natural language processing (NLP) and/or automatic speech recognition (ASR) techniques.

Classifier 320A processes the feature vector and context information for the new content item (e.g., by a machine learning model, etc.), and identifies one or more value curves of other content items associated with the new content item (e.g., stored in database system 118, etc.) at operation 425. The value curves of the previous content items indicate values for the previous content items over time. The context information may include any attributes providing a context for the new content item (e.g., location, popularity of a brand, audience demographics, buying power, brand, event described, type of content, etc.). The context information may be provided by the user and/or extracted by feature mapper 310A using natural language processing (NLP) techniques as described above.

In one of the embodiments, the feature mapper 310A identifies the neighboring contents to the new content items at operation 450. Further, the feature mapper 310A generates the content genome as shown in FIG. 3B at operation 451. The identification of the neighboring contents may be performed by the by classifier 320A and/or combiner 330A.

Combiner 330A processes the identified value curves from classifier 320A to produce a value curve for the new content item at operation 430. The combiner may select the identified value curves or any portion of the identified value curves to use for producing the value curve for the new content item. By way of example, the combiner may filter the identified value curves based on various criteria (e.g., use a predetermined number of the identified value curves (e.g., with the highest probabilities, etc.), similarity metrics between the content item and content items associated with the identified value curves, most recent value curves, etc.). For example, the combiner may select the value curves with the highest probabilities, associated with content items having similarity to the new content item exceeding a similarity threshold, and/or within a certain time interval.

In an embodiment of the invention, the combiner 330A feed the combined value curves from operation 430 and generated content genome from operation 451 to the machine learning model at operation 452.

Alternatively, classifier 320A may be trained with additional features for filtering and produce a filtered set of value curves (e.g., substantially similar to the filtered value curves of combiner 330A described above) as the identified value curves for combiner 330A. For example, the classifier may employ any conventional or other nearest neighbor technique (e.g., K-nearest neighbor, etc.) to identify nearest value curves as described above.

The filtering of value curves (e.g., by classifier 320A and/or combiner 330A) may be used for various scenarios. For example, a new content item may refer to a same event (or include the same content) as prior content item. In this case, similarity metrics between feature vectors of the content items may be high and indicate a very close similarity. The similarity metrics may use weighted features that focus on the features that may identify a same event or content (e.g., topic, keywords, temporal features, location of events, nature of event, brand, proximity to event, buying power, co-location in space and time, types of users, etc.). The value curves may be filtered in these instances based on a temporal requirement (e.g., within a certain time interval, etc.).

Further, a new content item may refer to a new occurrence of a previous type of event within prior content items. The similarity metrics may use weighted features that focus on the features that may identify a same type of event (e.g., topic, audience, location of events, brand, buying power, type of users, nature of event etc.). The value curves may be filtered in these instances based on the weighted features to select value curves of content items associated with the same type of event.

The selected value curves of the previous content items are combined based on a weighted sum of values of each value curve to produce values for the value curve for the new content item. This may be expressed as follows:

$${N}_{0} ( value , t ) = \sum ( {W}_{i} * {N}_{i} ( value , t ) )$$

where N₀ is the value curve for the new content item, i is an index for a quantity of previous content items (or value curves), t is time, “value” is a value from the value curve at time t, Wᵢ is a weight value for an i^{th} content item, and Nᵢ is a value curve for an i^{th} content item.

The summation is performed over the selected value curves of content items that have been analyzed. The values for the value curve of the new content item (at a time t) are calculated by multiplying each weight value (W) by the corresponding value (at time t) from the value curve of an associated content item (Nᵢ (value, t)), and summing the results over the previous content items. The resulting values represent the value curve for the new content item being analyzed.

The weight values for combining the selected value curves may be determined based on any desired criteria. For example, conventional or other natural language processing (NLP) techniques that consider similarities between the new content item and previous content items and/or other factors (e.g., popularity of a brand, audience demographics, buying power, brand, event described, type of content, word count, keywords, venue/location, type of readers, a language model, etc.) may be used to determine weight values. Some of the factors (e.g., brand, buying power, type of readers, factors without a quantifiable measurement, etc.) may be associated with predetermined weights that may be used to determine the weight values. For example, well-known brands may be assigned higher weights than lesser-known brands. The predetermined weights for the factors may be summed or otherwise combined, and/or used in combination with similarity or other metrics to determine the weight values for the value curves. In addition, neural networks may be used in the Natural Language Processing (NLP) to analyze the content item and provide insights for weight values (e.g., indicate relevant factors, etc.).

By way of example, the probabilities for the identified value curves from classifier 320A may be used as weight values (or combined with weight values from other factors). Further, similarity metrics between feature vectors of the new content item and previous content items may be used as weight values (or combined with weight values from other factors). For example, the similarity metric between the feature vectors may include any conventional or other distance or similarity metric (e.g., Euclidean or other distance, cosine similarity, etc.).

The weight values may be dynamically changed over time based on monitored user activity. For example, changes in user activity (e.g., accesses, transactions, etc.) that satisfy a threshold (e.g., change in an activity increases or decreases beyond a threshold amount, etc.) may initiate a change to feature weight values. By way of example, a feature weight value may be adjusted by a set amount, or by an amount corresponding to a percentage change in the activity (e.g., a 10% increase (or decrease) results in a 10% increase (or decrease) of a weight value for a corresponding feature, etc.).

In addition, portions of the value curves of associated content items may be used to produce corresponding portions of the value curve for the new content item. For example, a portion of a value curve for the new content item (corresponding to a desired time interval) may be produced from corresponding portions of value curves of associated content items having certain similar features (e.g., types of users, buying power, etc.). The values form these value curves for the desired time interval are weighted and summed to produce the corresponding portion for the value curve of the new content item in substantially the same manner described above. In addition, a unique or outlying user may similarly enable portions from value curves (with certain similar features and corresponding to the time of the unique user) to be combined to produce a corresponding portion of the value curve for the new content item in substantially the same manner described above.

Once a value curve for the new content item is determined, the value curve indicates predictions for values of the new content item over time. This curve is updated along with value curves for other content items (e.g., to continually correct the values or value predictions) based on user activity. adaptive engine 350A continuously monitor user activity including user interactions, content consumption patterns, and engagement metrics at operation 452. In particular, adaptive engine 350A updates the value curves for the content items based on user activity (e.g., recorded in ledgers for content items in database system 118, etc.) at operation 435. When the value curves are updated, the adaptive engine provides the updated value curves to value module 340A to update values for corresponding content items based on the value curves at operation 440. The value curves are followed over time, where a value for a content item is retrieved from a corresponding value curve for a current time. This enables the value for a content item to continuously be updated in real-time. The value curves and values for the content items are continuously updated at operations 435 and 440 (e.g., to continuously correct the values or value predictions), and are performed during the processing of new content items described above.

Adaptive engine 350A preferably utilizes a plurality of parallel hardware or virtual processors to process and/or update value curves and values for content items in parallel in order to increase computing performance. The adaptive engine may assign processing (e.g., updating value curves, updating values for content items, etc.) to the processors in various manners. For example, the adaptive engine may assign processing in a round robin or sequential fashion to a next processor, or to a next available processor. Further, the adaptive engine may employ any conventional or other load balancing techniques to assign processing based on metrics indicating a processing load on a processor (e.g., queued processes or jobs, throughput, processing speed, hardware or memory usage, etc.). In this case, processing may be assigned to processors providing the fastest completion times (e.g., having the lowest processing loads, fastest throughput or processing speed, etc.). The load balancing optimizes processing speed and performance.

The updating of value curves and processing of new content items are performed as described above until a termination condition occurs (e.g., power down, interruption, etc.) as determined at operation 445.

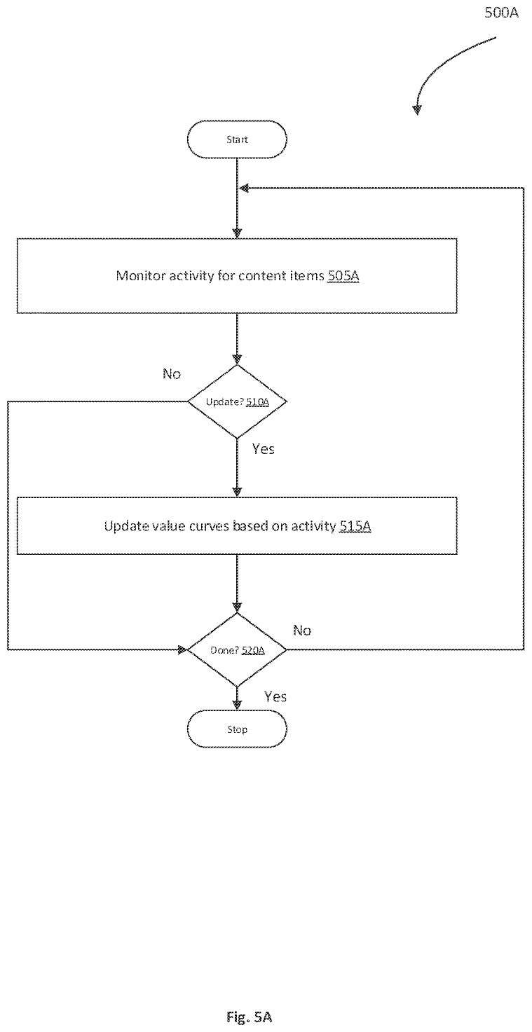

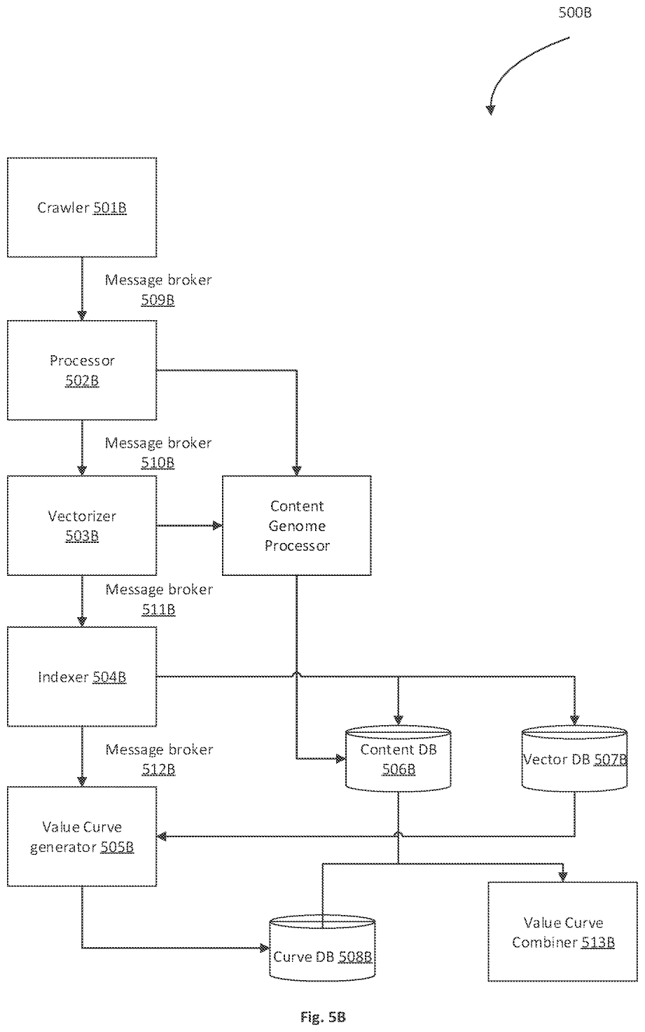

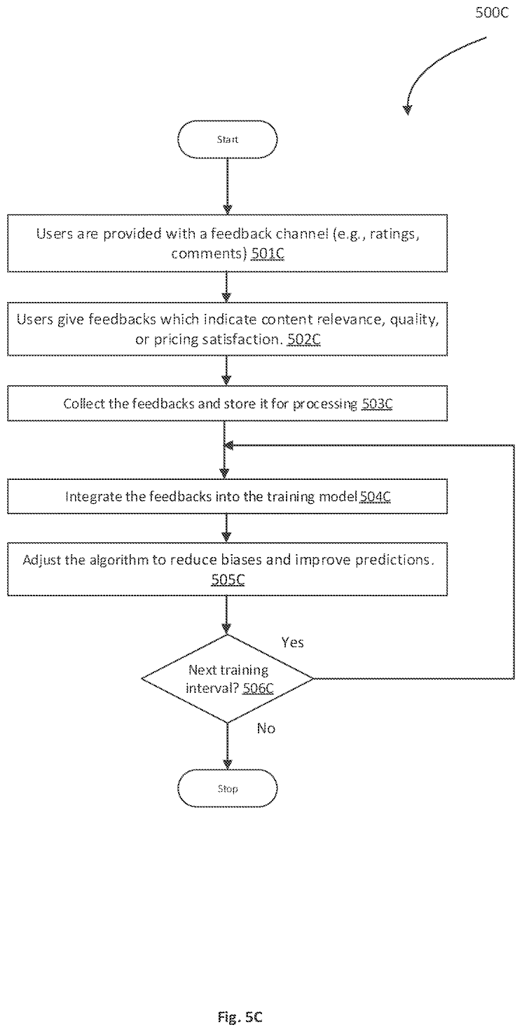

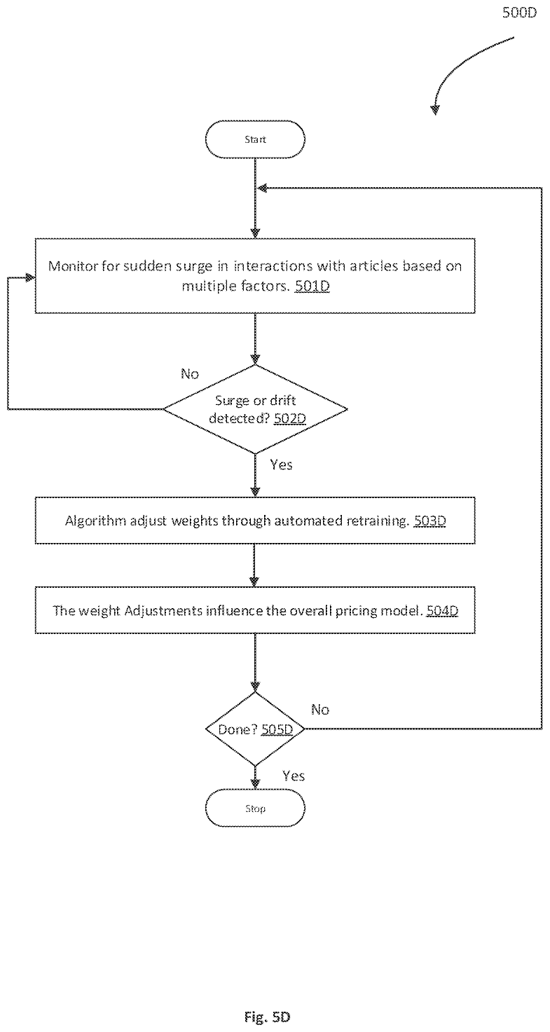

A manner of updating value curves (e.g., via adaptive engine 350A and server system 110 and/or client system 114) according to an embodiment of the present invention is illustrated in FIG. 5. This may correspond to operation 435 of FIG. 4. Initially, adaptive engine 350A refines a value curve for a content item based on real-time user behavior to generate an updated value curve (e.g., reflecting corrected values or value predictions based on the user behavior). As users interact with a content item, the updated value curve is calculated in real-time using an adaptive technique. The updated value curve reflects the current demand for the content item and is used to further refine the value curve in subsequent iterations of the adaptive technique.

External factors may be considered that impact the updated value curve, such as changes in the overall market, shifts in consumer behavior, and other relevant events. Neural networks or other natural language processing (NLP) techniques may be used in the adaptive technique to analyze the real-time data and provide insights with respect to the factors.

As more data is collected over time, adaptive engine 350A continues to refine predictions and adjust value curves accordingly. The initial and updated value curves become increasingly similar, reflecting the ability to accurately predict demand for the content items.

Adaptive engine 350A may maximize revenue generated from transactions for the content items. This is achieved by continuously refining the initial value and updated value curves to accurately reflect demand and optimize values in real-time. Neural Networks or other natural language processing (NLP) techniques may be used in analyzing data, providing insights, and refining the predictions to optimize the value for maximum revenue generation.

Adaptive engine 350A monitors user or other activity with respect to content items at operation 505A. The activity may be captured by a user interface on client system 114 (e.g., via interface module 120, etc.), and provided to adaptive engine 350A of server system 110 (e.g., either directly or via storage in database system 118). The activity may include any online or other activity with respect to a content item (e.g., clicks to access/initiate a transaction, cursor hover time, selection of content, views of advertisements, etc.), and information for the activity may be stored in a ledger of a corresponding content item as described above.

Adaptive engine 350A may update a value curve for a content item at any desired time interval (e.g., seconds, minutes, hours, etc.) to enable activity data to be measured and accumulated. The time intervals may be the same or different for different content items. In addition, adaptive engine 350A may update a value curve for a content item prior to expiration of a time interval in response to an event, such as certain behavior in user activity data. The behavior may include any outlier, anomaly, or shift in activity. For example, a sharp increase (or spike) or decrease in transactions or other activity (e.g., beyond a threshold amount, beyond a range, etc.) may initiate an update to a value curve of a corresponding content item.

When an update to a value curve of a content item is to be performed as determined at operation 510A (e.g., expiration of a time interval, occurrence of an event, etc.), adaptive engine 350A updates the value curve at operation 515A. The adaptive engine may use various techniques to update the value curve.

For example, adaptive engine 350A may update the value curve based on sensitivity or elasticity to value change. In this case, activity measurements (e.g., purchase or other transactions, etc.) are compared relative to value changes.

By way of example, adaptive engine 350A may monitor and obtain a series of activity measurements or observations (e.g., quantity of transactions, etc.), Y(t), during a time interval, τ, preceding the update, Y(t)=Y(0), Y(1), . . . Y(τ). The measurements may be stored in, and obtained from, corresponding ledgers for content items in database system 118. The sensitivity or elasticity at a point in time, d(t), may be based on a change in activity measurements at that point in time in the time interval relative to a corresponding difference in content item value. The sensitivity or elasticity at a point in time may be expressed as:

$$d ( t ) = \frac{Y ( t ) - Y ( t - 1 )}{{V}_{0} ( t ) - {V}_{0} ( t - 1 )}$$

where Y(t) is an activity measurement at time t, Y(t−1) is an activity measurement at time t−1, V₀(t) is a value of the content item at time t, and V₀(t−1) is the value of the content item at time t−1.

The aggregate (e.g., average) sensitivity or elasticity, E(τ), during the time interval is based on the sensitivity or elasticity at points in time in the time interval, and may be expressed as:

$$E ( τ ) = 1 / τ \sum d ( t ) , for t = 1 to τ .$$

The aggregate sensitivity or elasticity may be used in various manners to update the value curve. By way of example, the aggregate elasticity may be used to determine a scaling factor that is applied to a current value curve. The scaling factor, a, may be determined based on a relative position of the aggregate elasticity within an elasticity value range. For example, the elasticity value range may be bounded by a minimum value for the elasticity, eₘᵢₙ, and a maximum value for the elasticity, eₘₐₓ. These minimum and maximum values may be determined based on value ranges for the activity measurements applied to the above expression for aggregate elasticity.

The scaling factor, α, may be expressed as:

$$α = \frac{E ( τ ) - {e}_{min}}{{e}_{max} - {e}_{min}} , where 0 \leq α \leq 1$$

The scaling factor may be applied to a current value curve (e.g., multiply the scaling factor by the values in the current value curve, etc.) in order to produce an updated value curve. This may be expressed as:

$${V}_{1} ( t ) = α * {V}_{0} ( t )$$

where V₁(t) is the updated value curve, α is the scaling factor, and V₀(t) is the prior value curve.

Sine the value curves may be expressed as a polynomial function with coefficients as described above, the scaling factor may simply be applied to the coefficients to update the value curve. This avoids storage and calculation of the all of the data points, thereby increasing processing speed and conserving memory.

The scaling factor, α, may alternatively be applied to a Y-intercept of the value curve to update the value curve (e.g., shift the value curve by the scaling factor, etc.). In this case, the scaling factor may be applied to (e.g., multiplied by, etc.) the constant value representing the Y-intercept in the polynomial equation for the value curve. This avoids storage and calculation of all of the data points, thereby increasing processing speed and conserving memory.

In this case, the aggregate elasticity may serve as the gradient of a loss function for parameters (e.g., activity, value, etc.) of the current value curve or function and indicate a direction for an update, while an adjustment value from an adjustment curve may serve as a step size (or learning rate). The adjustment value is applied to the aggregate elasticity to form an adjustment for the current value curve. The adjustment curve may be a flat curve (e.g., a constant step size applied to the aggregate elasticity for set increments/decrements over time, etc.), or some other function or shape (e.g., reflecting user activity measurements over time).

The update to the value curve employing a learning technique (eg: gradient descent) may be expressed as:

$${V}_{1} ( t ) = {V}_{0} ( t ) + E ( τ ) * {V}_{ADJ} ( t )$$

where V₁(t) is the updated value curve, V₀(t) is the current value curve, E(τ) is the aggregate elasticity (e.g., serving as a gradient of a loss function for parameters of the current value curve), and V_{ADJ}(t) is the adjustment curve (e.g., step size or learning rate).

Since the value curves may be expressed as a polynomial function with coefficients as described above, the adjustment may simply be applied to the parameters of the polynomial function to update the value curve. This avoids storage and calculation of all of the data points, thereby increasing processing speed and conserving memory.

In addition, various conventional or other techniques may be used to update the value curve based on user activity (e.g., stochastic gradient descent (SGD), adaptive gradient algorithm (AdaGrad), root mean square propagation (RMSProp), Adaptive Moment Estimation (Adam), etc.). For example, stochastic gradient descent (SGD) is similar to gradient descent, but updates parameters based on a randomly selected subset of training data. Adaptive gradient algorithm (AdaGrad) adapts a learning rate for each parameter based on historical gradient information (e.g., parameters with sparse gradients have a higher learning rate while parameters with dense gradients have a lower learning rate). Root mean square propagation utilizes a moving average of the squared gradient to scale a learning rate for each parameter. Adaptive moment estimation (Adam) combines gradient descent, SGD, AdaGrad, and RMSProp, and adapts the learning rate for each parameter based on historical gradient information and a historical moving average of the gradient.

The updating of value curves is performed as described above until a termination condition occurs (e.g., power down, interruption, etc.) as determined at operation 520A.

FIG. 5B is a block diagram 500B that illustrates an example implementation of the invention using data from a crawler and generating value of digital contents using message brokers and databases, in accordance with an exemplary embodiment of the disclosure. A crawler 501B collects Uniform Resource Locators (URLs) from multiple sources, scrapes their raw Hypertext Markup Language (HTML) and sends it across on Message broker (e.g.: RabbitMQ) to a processor 502B. The processor 502B will take the raw HTML as input, and parse it to extract the content and the meta data of the article. The vectorizer 503B and the indexer 504B indexes the digital content information and vectors, so that it's readily available to query in a way that similar articles can be retrieved, then uses Message broker to signal that the digital content is ready to be presented with value curve generator 505B. A content Database (DB) 506B keeps updated by the indexer 504B, and a vector DB 507B is maintained for the value curve generator 505B by the indexer 504B. The value curve generator 505B use the content database (DB) 506B and the vector DB 507B to generate the output of the digital contents. Further, a curve DB 508B is maintained by the value curve generator 505B.

In one of the embodiments on the implementation of the invention, a crawler 501B collects Uniform Resource Locators (URLs) from multiple sources, scrapes their raw Hypertext Markup Language (HTML) and sends it across on message broker (e.g.: RabbitMQ, Apache Kafka, ZeroMQ, etc.) to the processor. The processor will take the raw HTML as input, and parse it to extract the content and the meta data of the digital content. Further, the reinforcement learning engine indexes the digital content information and vectors, so that it's readily available to query in a way that similar digital content can be retrieved, then uses message broker to signal that the digital content is ready to be presented with information of digital contents.

FIG. 5C is a procedural flowchart illustrating feedback loops from the users integrated into the system to retrain the machine learning model. The dynamic pricing system incorporates feedback loops to enhance the accuracy and effectiveness of its machine learning models. These feedback loops are designed to continuously collect and integrate user feedback into the model training process, thereby improving its performance over time. The feedback mechanism provides users with a dedicated interface, such as ratings or comments, through which they can express their opinions regarding content relevance, quality, or pricing satisfaction. This feedback is then systematically incorporated into the training process, ensuring that the model adapts to changing user preferences and market dynamics. Additionally, the system implements regular model updating procedures, wherein the models are retrained at predefined intervals based on the collected feedback. Through this process, the algorithms are adjusted to reduce biases and improve predictions, ultimately leading to more accurate and responsive pricing strategies. Continuous learning mechanisms are also employed to ensure that the model evolves in real-time, enabling it to effectively adapt to evolving user preferences and market trends.

The feedback loop mechanism, as depicted in FIG. 5B of the patent specification, delineates a multi-step process for incorporating user feedback into the dynamic pricing system. First, at step 501C, users are furnished with a designated feedback channel, allowing them to provide ratings or comments indicative of content relevance, quality, or pricing satisfaction. This feedback, as indicated in step 502C, is then gathered and stored for subsequent processing within the system. Upon collection, as detailed in step 503C, the feedback data is systematically integrated into the training model of the dynamic pricing system. Following integration, in step 504C, the system adjusts its algorithmic framework to mitigate biases and refine predictions based on the assimilated feedback. Furthermore, step 505C underscores the iterative nature of the process, with the algorithm continuously adapting to ensure optimal pricing strategies. Finally, the inclusion of a decision box at step 506C serves to determine the opportune moment for initiating the next training interval, thereby facilitating timely updates and enhancements to the pricing model in response to evolving user preferences and market dynamics.

FIG. 5D is a procedural flowchart illustrating dynamically changing weight values based on a surge. The dynamic pricing system incorporates mechanisms for dynamically adjusting weight values to ensure adaptability and responsiveness to changing user preferences and market dynamics. These mechanisms utilize user activity monitoring, which involves tracking user interactions, content consumption patterns, and engagement metrics in real-time to identify trends and patterns. By continuously monitoring user behavior, the system can detect sudden surges in interactions with articles on specific topics, indicating changing user preferences or emerging trends. Once identified, these triggers prompt the system to make adjustments to the weight values associated with relevant content attributes. For example, if there is an increased interest in articles on a particular topic, the system may adjust the weights related to that topic to reflect its higher relevance or value to users. These adjustments have a direct impact on the overall pricing model, influencing the prices assigned to related content. For instance, an increased weight on trending topics may lead to higher prices for articles within those topics, reflecting their perceived value and demand among users. By dynamically changing weight values in response to evolving user behavior and market trends, the system can ensure that its pricing strategies remain relevant and competitive, ultimately enhancing user satisfaction and maximizing revenue.

The process outlined in FIG. 5B of the patent specification entails monitoring for sudden surges in interactions with articles, facilitated by a multi-step approach. Initially, at step 501D, the system continuously monitors various factors to identify abrupt increases in user engagement with content. Upon detection, as denoted by step 502D, a decision box evaluates whether a surge or drift in interactions has occurred, determining the subsequent course of action. Should a surge be detected, step 503D entails the automatic adjustment of algorithmic weights through retraining, optimizing the dynamic pricing model in response to evolving user behavior. Subsequently, step 504D emphasizes that these weight adjustments play a pivotal role in shaping the overall pricing model, ensuring its responsiveness to shifting market dynamics and user preferences.

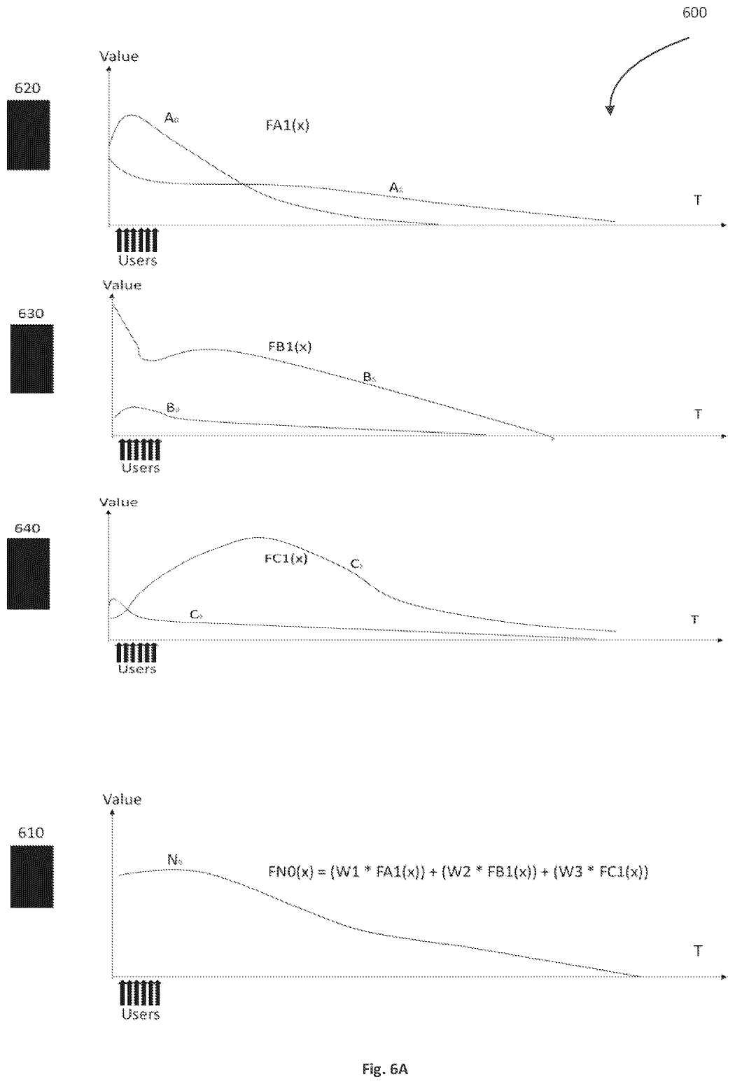

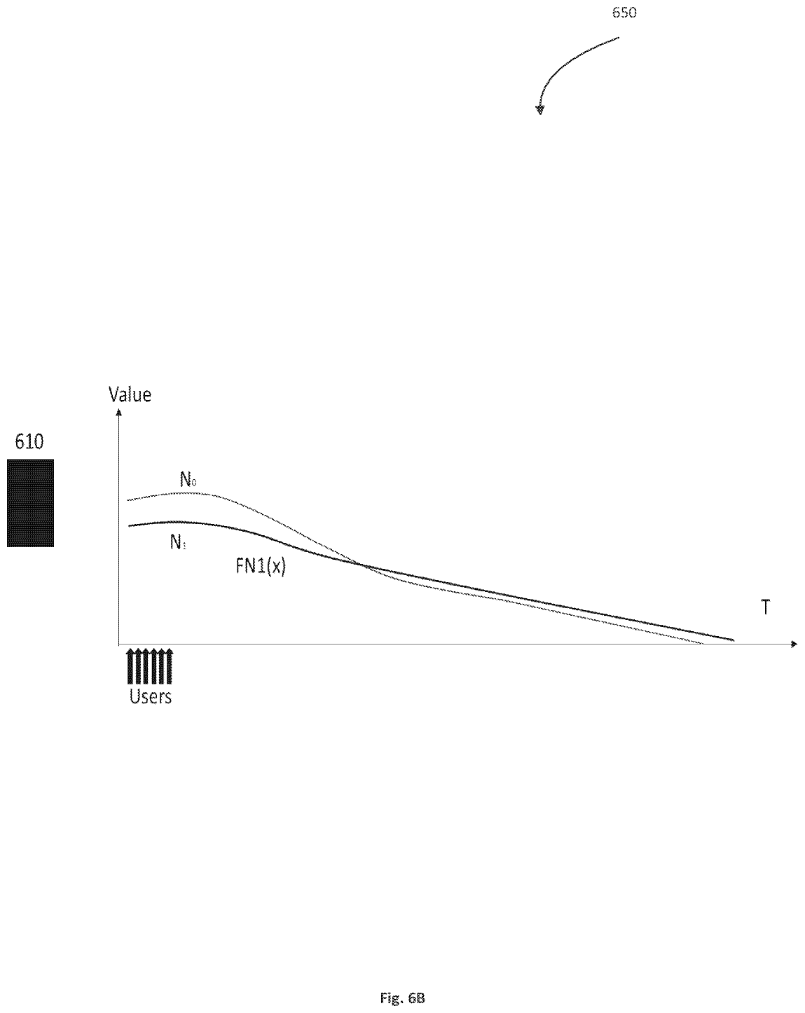

An example of generating and updating a value curve for a new content item is illustrated in FIGS. 6A and 6B. Initially, reference value curves A₀, B₀, and C₀ are generated for an initial set of content items 620, 630, and 640. The reference value curves indicate values for the corresponding content items over time, and may be generated based on experimental data (e.g., a randomized control trial (RCT) of user activity with respect to the content items, etc.) as described above. The reference value curves are updated based on user activity in substantially the same manner described above to produce updated reference value curves A₁ (e.g., represented by F_{A1}(x) as viewed in FIG. 6A), B₁ (e.g., represented by F_{B1}(x) as viewed in FIG. 6A), and C₁ (e.g., represented by F_{C1}(x) as viewed in FIG. 6A) that may be stored as new value curves in database system 118.

A new content item 610 is provided, and a value function No for the new content item is determined based on the updated value curves of previous content items 620, 630, 640. In particular, feature mapper 310A analyzes the new content item and extracts features from the new content item to produce a feature vector in substantially the same manner described above. Classifier 320A processes the feature vector and context information for the new content item (e.g., by a machine learning model, etc.) in substantially the same manner described above, and identifies the updated value curves of content items 620, 630, and 640 as being associated with new content item 610.

Combiner 330A processes the identified value curves from classifier 320A to produce a value curve No for new content item 610 (e.g., represented by F_{N0}(x) as viewed in FIG. 6A) in substantially the same manner described above. The value curves are combined based on a weighted sum of values of each updated value curve for content items 620, 630, and 640 to produce values for the value curve for the new content item 610. This may be expressed as follows:

$${F}_{N 0} ( x ) = ( W 1 * {F}_{A 1} ( x ) ) + ( W 2 * {F}_{B 1} ( x ) ) + ( W 3 * {F}_{C 1} ( x ) )$$

where F_{N0}(x) is the value curve for the new content item, F_{A1}(x) is the updated value curve for content item 620, F_{B1}(x) is the updated value curve for content item 630, F_{C1}(x) is the updated value curve for content item 640, and W1, W2, and W3 are weight values.

Once a value curve for new content item 610 is determined, adaptive engine 350A updates this curve based on user activity in substantially the same manner described above to produce an updated value curve N₁ (e.g., represented by F_{N1}(x) as viewed in FIG. 6B). The value curves for the other content items 620, 630, and 640 are also updated by adaptive engine 350A based on user activity in substantially the same manner described above.

New content items and various value curve updates may be performed since the initial value curve for a content item was produced. In this case, the content item may be re-submitted to classifier 320A to identify a new set of value curves of associated content items. The new set of value curves may include updated value curves and/or value curves of subsequently added content items. In addition, a context for the content item may have changed which may also produce a new set of value curves from classifier 320A. The set of value curves may be combined in substantially the same manner described above to produce an updated value curve for the content item. The content item may be re-submitted to the classifier at any desired time intervals or conditions (e.g., daily, weekly, in response to a certain quantity of updates, in response to a certain quantity of new content items, etc.). The time interval is preferably longer than the time interval for updating value curves. This enables the value of the content item to change based on user activity of related content items (e.g., in addition to user activity of the content item).

In addition, a content item may include content associated with a live event (e.g., podcast, streaming media of the event, etc.). For example, audio of the event may be transcribed to text and analyzed via any conventional or other natural language processing (NLP) and/or automatic speech recognition (ASR) techniques. An initial topic may be determined, and a value curve and corresponding value for the content item may be produced in substantially the same manner described above. However, when a topic change (e.g., during a podcast, interview, etc.) is detected (e.g., via any conventional or other natural language processing (NLP) techniques, etc.), the content item is re-submitted to value engine 300A to determine a new value curve based on the new topic in substantially the same manner described above. In this case, the new topic may be associated with new features extracted by feature mapper 310A that enable classifier 320A to identify a different set of value curves of content items associated with the new topic in substantially the same manner described above. These identified value curves may be combined to produce a new value curve for the content item that values the content item based on the new topic. The new value curve for the content item is updated as described above, where the value curve for the content item (and consequently the value) may dynamically change as topics change in the live event.

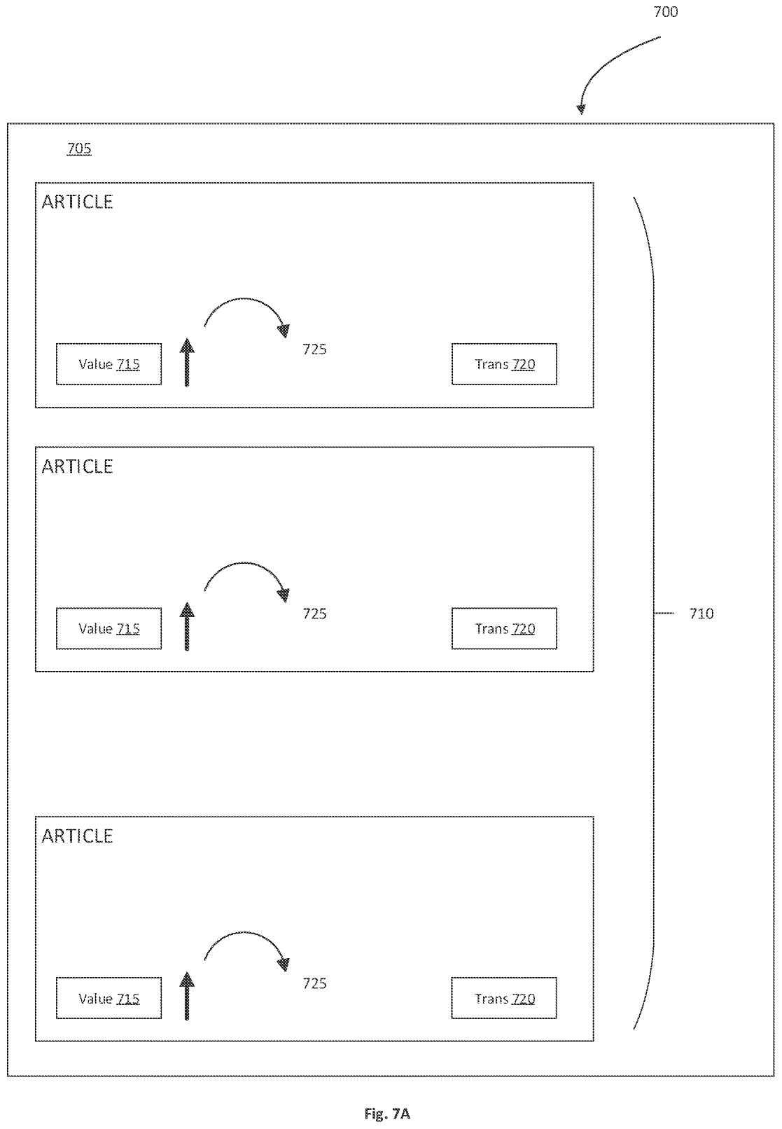

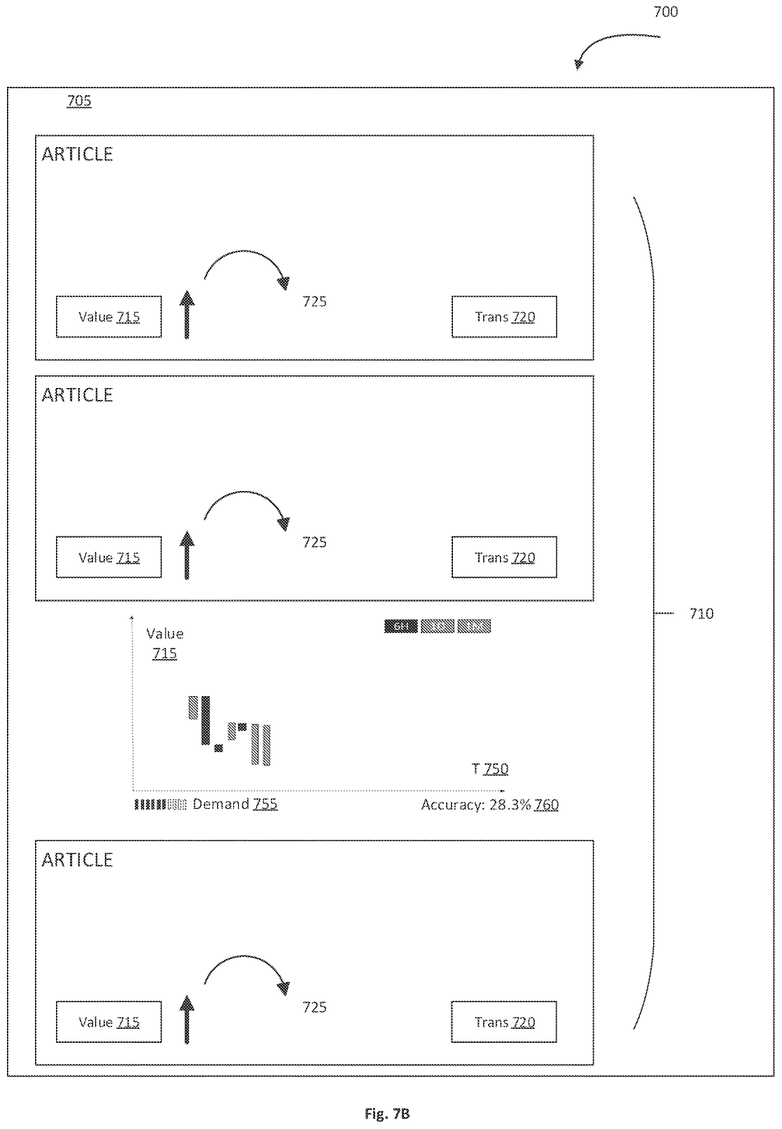

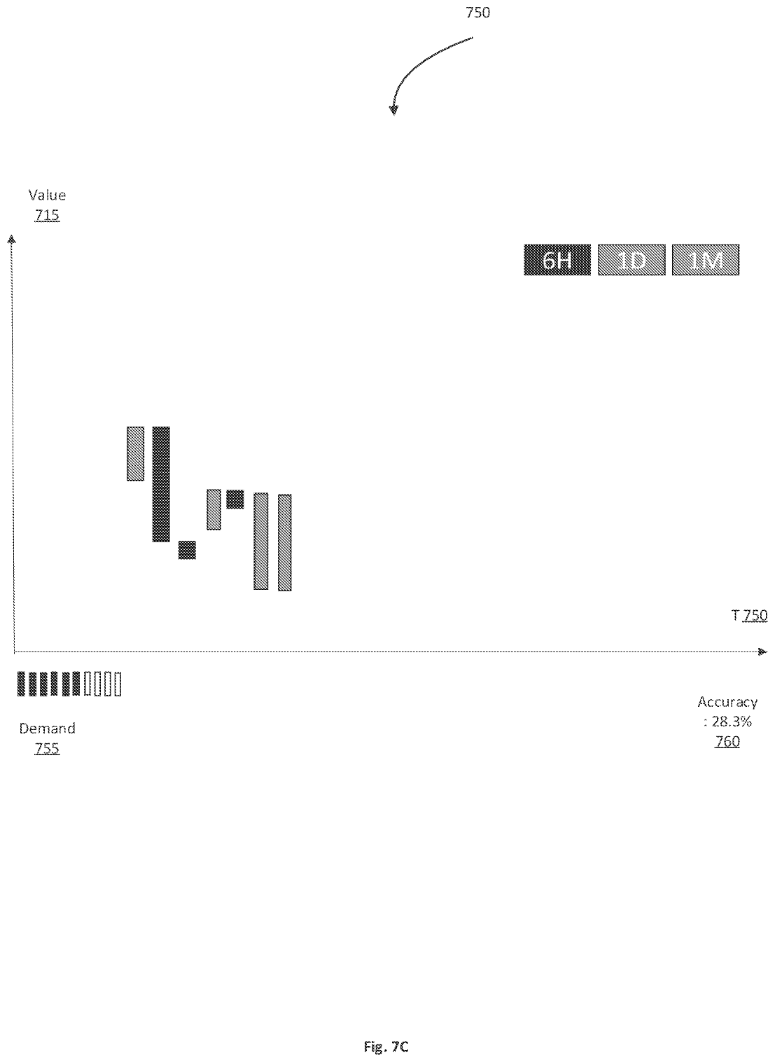

An example graphical user interface 700 providing content items and values changing in real-time is illustrated in FIGS. 7A-7B. Initially, value module 340A may generate graphical user interface 700 for presentation on a client system 114. The value module may receive search parameters entered by a user from the client system, and perform a search for desired content items satisfying the search parameters. User interface 700 includes a display area 705 presenting content items 710 (e.g., from the search, etc.). Each content item 710 is provided with corresponding information (e.g., title, author, source, etc.), a value area 715 indicating a value for the content item, and an actuator 720 for obtaining the content item (e.g., a link, a transaction actuator to obtain the content item, etc.). In addition, value area 715 includes an indicator 725 (e.g., arrow, etc.) indicating a trend or direction for the value (e.g., increasing or decreasing, etc.). The indicator may further be color coded to indicate the trend or direction (e.g., green for increasing, red for decreasing, yellow for stable, etc.). By way of example, the content items correspond to news or other articles, and the value corresponds to a purchase price. However, any types of content and values may be utilized.

The values for content items 710 are determined by value module 340A from corresponding value curves, and are continuously updated over time. Accordingly, the values provided by graphical user interface 700 may be constantly updated or changing (e.g., similar to a continuously updated and changing stock ticker, etc.). In addition, the content items may be sorted based on value (e.g., ascending or descending order, etc.). In this case, the order of the content items may be dynamically changed in accordance with the updated or changing values.

Referring to FIG. 7B, a user may select or actuate a presented content item to display further information. By way of example, graphical user interface 700 may present a content item 730 in display area 705. The content item is provided with corresponding information (e.g., title, author, source, link, etc.), value area 715 indicating a value for the content item, and actuator 720 for obtaining the content item (e.g., a link, a transaction actuator to obtain the content item, etc.). In addition, value area 715 includes indicator 725 (e.g., arrow, etc.) indicating a trend or direction for the value (e.g., increasing or decreasing, etc.). The indicator may further be color coded to indicate the trend or direction (e.g., green for increasing, red for decreasing, yellow for stable etc.).

A user may further select or actuate content item 730 by manipulating an input device (e.g., a mouse, etc.) to move a cursor proximate or overlaying content item 730. The user may actuate the input mechanism (e.g., a selection action, etc.) or enable the cursor to hover over content item 730 for a sufficient time period. In response to the selection or hovering action, value module 340A may provide a data area 750 providing additional information for content item 730. Data area 750 includes a graphical representation of value of the content item over selectable time periods (e.g., number of hours, day, month, etc.).

Further, referring to FIG. 7C, data area 750 may indicate a level of demand 755 (e.g., a series of bars over a range scale, demand value or percentage, etc.) and an accuracy or confidence 760. The data area may be updated in real-time as information is collected and values are updated.

Present invention embodiments may provide various technical and other advantages. In an embodiment, the machine learning models may be continuously updated (or trained) based on feedback related to online user activity. For example, the classifier may initially identify related value curves. Once feedback is provided with respect to a content item (e.g., continuous monitoring of user activity, additional context information for the monitoring, etc.), the machine learning models may be updated (or trained) based on the feedback. By way of example, the user activity and/or context information may be used to update or train the machine learning models (e.g., update or train the machine learning models to adjust the probability (or change a classification) of a value curve for a content item, etc.). Thus, the machine learning models may continuously evolve (or be trained) to learn further attributes with respect to value curves as user activity is continuously monitored.

A present invention embodiment uses past content, value performance, and user data to train its value models for various content and formats. The present invention embodiment uses a vast amount of past content, its past value performance, and user behavior and transaction data to train its value models across different content types, such as sports, politics, medicine, business, finance, biology, science, and various formats like articles, videos, news items, blogs, etc. Further, deep learning algorithms may be used to analyze real-time user behavior and past performance to generate appropriate value performances. The deep learning algorithms may be used to analyze and understand all user potential transaction behavior of every new content item, at any given moment, based on real-time user behavior, similar content, and past content value performance and user past transaction performance to generate appropriate values.

A present invention embodiment may constantly improve its value models and forecasts through unsupervised learning to identify economic patterns and relationships. The present invention embodiment may constantly learn and improve its value models through unsupervised learning, which enables it to identify economic patterns and relationships in value performance without explicit guidance. In addition, a present invention embodiment utilizes natural language processing (NLP), adaptive algorithms, and neural networks for accurate and fair value for both users creating content and users obtaining content over time. The present invention embodiment utilizes natural language processing (NLP), and its adaptive algorithms and neural networks to become even more accurate and efficient in its value decisions over time and to ensure fair value for both users creating content and users obtaining content.

In one of the embodiments of the invention, a method to generate Quantitative Market Value (QMV) Forecast with uncertainty is disclosed. Given a set of contents, the forecast for a particular content C, at time t, now including uncertainty, is represented by the equation:

$${Forecast}_{c} ( t ) = f ( {\vec{CG}}_{c} , {\sum }_{i = 1}^{k} ( {w}_{i} \cdot Q M {V}_{{SC}_{i}} ( {i}^{′} ) ) ) + Y ( t )$$

Wherein, Forecast_{c}(t) is the forecasted value for content C, at time t, incorporating modeled uncertainty. ƒ is a function that combines the content genome of content C with the weighted historical QMV of similar content. \vec{CG}_{c} is the content genome, a numerical vector representing the characteristics of content C. SCi represents the i-th similar content to content C. k is the number of similar contents considered for the forecast, determined by similarity score. wᵢ is the weight (normalized similarity score) assigned to the i-th similar content. QMV_{SC}_{ᵢ}(t′) is the QMV of the i-th similar content at the historical time t′. Y(t) represents the variability at time t modeled as a stochastic process, adding uncertainty to the forecast. It is a normally distributed random variable with mean u and a time-varying standard deviation σ(t). The distinction between t and t′ is crucial: t: Refers to the current or a future time point for which the forecast is being made. It represents the moment for which we want to predict the outcome using the forecast function. When we refer to t+1, t+2, . . . , we are considering forecasts for future time points, extending from the present into the future. t′: Represents a historical time point for each similar content SCᵢ. It is the time at which the historical QMV was observed for the similar contents. The historical data at t′ is used to inform the forecast for the current or future time t. The t′ reflects the past performance or behavior of contents that are similar to content C, and it's understood that each SC; has its own historical timeline with t′+1, t′+2, . . . marking subsequent points in history.

In another of the embodiments of the invention, a method to generate Quantitative Market Value (QMV) is disclosed. The initial point estimate of the forecast for a particular content C at the initial time t=0 is defined as the Quantitative Market Value (QMV). The QMV represents a baseline value from which future forecasts are derived.

$$Q M {V}_{c} = {f}_{0} ( {\vec{CG}}_{c} , {\sum }_{i = 1}^{k} ( {w}_{i} \cdot Q M {V}_{{SC}_{i}} ( {t}^{′} ) ) )$$

Wherein, QMV_{c} is the Quantitative Market Value for content C at the initial forecast point t=0. ƒ₀ is a function that combines the content genome of content C with the weighted sum of historical values of similar content. \vec{CG}_{c} is the content genome, a numerical vector representing the characteristics of content C. SCi represents the i-th similar content to content C. k is the number of similar contents considered for the forecast, determined by similarity score. wᵢ is the weight (normalized similarity score) assigned to the i-th similar content. QMV_{SC}_{ᵢ}(t′) is the QMV of the i-th similar content at the historical time t′. The QMV for content C, at t=0 serves as the foundational value in forecasting, reflecting an amalgamation of the intrinsic properties of the content and the aggregated, weighted historical performances of similar contents. This initial estimate is crucial for setting the baseline from which future forecasts are projected, providing a starting point that encapsulates both the content's characteristics and the empirical data from the market performance of related contents.

In an embodiment of the invention, a method to generate Quantitative Market Value (QMV) Adaptive value is disclosed, wherein the generated QMV Adaptive value may be used by partners. The QMV Adaptive model for content C, at time t, denoted as QMVC(t), integrates several critical components to dynamically adapt the QMV based on current and recent trends data: The equation representing the QMV Adaptive is given by:

$$Q M {V}_{c} ( t ) = f ( {\vec{CG}}_{c} , U {E}_{C} ( t ) , E E {R}_{C} ( t ) , {\sum }_{i = 1}^{k} ( {w}_{i} \cdot Q M {V}_{{SC}_{i}} ( t - 1 ) ) )$$

Wherein, \vec{CG}_{c} is a numerical vector capturing the inherent attributes of the content, reflecting its fundamental characteristics. User Engagement Factor UE_{c}(t) which measures the level of user interaction with content C, at time t, providing insights into the content's appeal and engagement with the audience. Entity and Event Relevance Factor EER_{c}(t) represents the timeliness and significance of entities and events related to content C, at time t, adjusting the QMV based on external influences that might impact content performance. The weighted QMV of contextually similar content incorporates the aggregated, weighted QMV values from similar content (SCi) at a prior time (t−1), leveraging the recent performance trends. These components collectively enhance the model's ability to provide a nuanced and dynamic prediction. The inclusion of user engagement and the relevance of related entities and events, alongside the content's intrinsic attributes and recent performance trends data, ensures a comprehensive real time relevance of QMV.

In another embodiment of the invention, a method to generate Quantitative Market Value (QMV) Adaptive value is disclosed, wherein the value may be shared with non-partners. QMV Adaptive model for content C, at time t, in the absence of User Engagement (UE) data, simplifies the equation by removing the UE term. This modification ensures the model's applicability when specific engagement metrics are unavailable in case of non-partner publisher/individual creators. The revised equation is given by:

$$Q M {V}_{c} ( t ) = f ( {\vec{CG}}_{C} , E E {R}_{c} ( t ) , {\sum }_{i = 1}^{k} ( {w}_{i} \cdot Q M {V}_{{SC}_{i}} ( t - 1 ) ) )$$

Wherein, the refined version of the QMV Adaptive model, despite the absence of direct user engagement metrics, employs a multifaceted approach by integrating the content genome, the significance of entities and events, and the recent performance metrics of similar content. The key factor here is the price propagation mechanism. This mechanism ensures that the Quantitative Market Value (QMV) remains responsive and accurate, even for content that lacks direct user engagement metrics. It does so by leveraging insights gained from similar content that has direct user engagement data, effectively “propagating” these insights to adjust the QMV of the target content.

In one of the embodiments of the invention, a method to refresh the Quantitative Market Value (QMV) Forecast value is disclosed. The refresh function ensures that the forecast incorporates the most current data, reflecting any recent changes in the market or the characteristics of similar content. When the forecast refresh function is executed, the model is re-executed to account for any changes in the set of similar content or updates.

$${Forecast}_{c}^{refresh} ( t ) = f ( {\vec{CG}}_{c} , {\sum }_{i = 1}^{k} ( {w}_{i} \cdot Q M {V}_{{SC}_{i}} ( {t}^{′} ) ) )$$

### Wherein,

$${Forecast}_{c}^{refresh} ( t )$$

is the refreshed forecast value for content C, at time t, incorporating the refresh function.

It will be appreciated that the embodiments described above and illustrated in the drawings represent only a few of the many ways of implementing embodiments for monitoring online activity for real-time ranking of content.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., communications software, server software, content module 116, interface or browser module 120, etc.). These systems may include any types of monitors and input devices (e.g., keyboard, mouse, voice recognition, etc.) to enter and/or view information.

It is to be understood that the software (e.g., content module 116, interface or browser module 120, etc.) of the present invention embodiments may be implemented in any desired computer language and could be developed by one of ordinary skill in the computer science based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., content module 116, interface or browser module 120, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., values, content items, historical data, etc.).

The present invention embodiments are not limited to the specific tasks or algorithms described above, but may be utilized for monitoring user activity and determining values for any items or objects in real-time.

A content item may be any type of digital or electronic item or object (e.g., document, web page, file, data object, etc.) containing any type, or a combination of any types, of data (e.g., text, multimedia, video, audio, image, streaming data, etc.). For example, a content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc.

The value of a content item may be any value within any desired numerical or other range, and may represent any attribute of the content item (e.g., worth, price, rank, importance, relevance, etc.). A value curve for a content item may be any function, plot, graph element, or other object (e.g., table, list, etc.) conveying values for the content item over time (e.g., a flat curve or line, any curve, any combination of curved and/or linear portions, step-wise function or graph, etc.). A reference value curve may be generated in any fashion (e.g., a randomized control trial (RCT) or other experiments, randomly, pre-selected or default data, etc.). The value curves may be updated continuously at any desired time intervals (e.g., seconds, minute, etc.), while the values may be updated continuously (in real-time) according to the value curves. The value curves may extend over any desired time interval (e.g., minutes, hours, days, weeks, months, years, etc.).

The weighting of value curves and features may use any weights within any desired value range, and may be assigned based on any desired attributes or conditions (e.g., user activity, assigned by a user, etc.), and the weights may be determined by algorithm and changes with model/algorithm updates.

The feature vector may include any quantity of dimensions or elements each indicating a feature of a content item. The features may include any quantity of any types of features (e.g., keywords, topics, events, word count, word frequency, word embeddings, term frequency-inverse document frequency (tf-idf), etc.). The contextual information may include any attributes providing a context for the content item (e.g., location, popularity of a brand, audience demographics, buying power, brand, event described, type of content, etc.).

The classification may be performed by any conventional or other machine learning models (e.g., mathematical/statistical; classifiers; feed-forward, deep learning, recurrent, convolutional or other neural networks; unsupervised, supervised, or semi-supervised; etc.). The machine learning model may use unsupervised or supervised learning. Unsupervised machine learning uses data that has not been labeled, classified, or categorized. For example, an unsupervised machine learning model (e.g., neural network, etc.) may be trained with a training set of unlabeled data, where the neural network attempts to produce the provided data and uses an error from the output (e.g., difference between inputs and outputs) to adjust weight (and bias) values. A supervised machine learning model (e.g., neural network, etc.) may be trained with a training set including input and known output, where the neural network attempts to produce the provided output and uses an error from the output (e.g., difference between produced and known outputs) to adjust weight (and bias) values (e.g., via backpropagation or other training techniques).

The value curves may be updated using any conventional or other techniques based on any metrics indicating sensitivity of activity to value change (e.g., scaling factors, gradient descent, stochastic gradient descent (SGD), adaptive gradient algorithm (AdaGrad), root mean square propagation (RMSProp), Adaptive Moment Estimation (Adam), etc.).

The activity may include any online or other activities by any entity with respect to content items (e.g., clicks to access/initiate a transaction, cursor hover time, selection of content items, views of advertisements, etc.). The measurements or observations for the activity may include any desired information (e.g., quantity of clicks to access/initiate a transaction, amount of cursor hover time, quantity of selections of content items, quantity of views of advertisements, quantity of purchase or other transactions, etc.).

Having described preferred embodiments of a new and improved system, method, and computer program product for monitoring online activity for real-time ranking of content, it is believed that other modifications, variations and changes will be suggested to those skilled in the art in view of the teachings set forth herein. It is therefore to be understood that all such variations, modifications and changes are believed to fall within the scope of present invention embodiments.

1. A method comprising:
receiving, via at least one processor, a digital content item containing content;
determining, via the at least one processor, a value for the content item based on values of one or more other content items associated with the digital content item, based on similarity of features of the digital content item and features of the other content items associated with the digital content item;
monitoring, via the at least one processor, online activity related to user interaction with the content item;
updating, via the at least one processor, the value for the content item in real-time based on online activity related to the user interaction; and
displaying, via the at least one processor, the value for the content item as the value changes in real-time.

2. The method of claim 1, further comprises:
determining that the content item is a new content item; and
upon determining that the content item is a new content item, extracting features from the content item.

3. The method of claim 2, further comprises:
identifying value curves of a one or more plurality of other content items associated with the new content item, the value curves providing predictions of values of the content item over time; and
combining the identified value curves to produce a value curve for the new content item.

4. The method of claim 3, wherein the value curves are identified using one or more machine learning models.

5. The method of claim 4, further comprises: classifying each value curve of content items by associating with a class associated with each value curve of content items by an output layer neuron.

6. The method of claim 5, further comprises: generating a set of reference value curves for an initial set of content items at operation, wherein the set of reference value curves is expressed as a set of polynomial functions.

7. The method of claim 6, further comprises: updating continually the value curve of the new content item and the value of the new content item, wherein the value curve is expressed as a polynomial function.

8. A method comprising:
receiving, via at least one processor, a new digital content item containing digital content;
extracting, via the at least one processor, one or more features of the new digital content item;
identifying, via the at least one processor, one or more associated digital content items based on the one or more features;
determining, via the at least one processor, a value curve of the new digital content item based on the value curves of the one or more associated digital content items, the value curve indicating a prediction of the values of the new digital content item over time;
monitoring, via the at least one processor, online activity related to user interaction with the new digital content item;
updating, via the at least one processor, the value curve for the new digital content item in real-time based on online activity related to the user interaction; and
displaying, via the at least one processor, the value for the new content item as the value changes in real-time.

9. The method of claim 8, wherein determining, via the at least one processor, a value curve of the new digital content item based on the value curves of the one or more associated digital content items comprises:
identifying value curves of the one or more plurality of content items associated with the new content item; and
combining the identified value curves to produce a value curve for the new content item.

10. The method of claim 9, wherein the value curves are identified using one or more machine learning models.

11. The method of claim 8 further comprises: classifying the value curve of new digital content item by associating with a class associated with each value curve of content items by an output layer neuron.
